(19) United States
(12) Patent Application Publication
(10) Pub. No.: US 2014/0115018 A1
(43) Pub. Date: Apr. 24, 2014

(54) Document Tracking and Management System and Methods

(71) Applicants: Robert J. Rieger, Novato, CA (US); Rick Francis, Pleasanton, CA (US)

(72) Inventors: Robert J. Rieger, Novato, CA (US); Rick Francis, Pleasanton, CA (US)

(21) Appl. No.: 13/659,259

(22) Filed: Oct. 24, 2012

(51) Int. Cl. G06F 17/30

(52) U.S. Cl. 707/827; 707/E17.01

(57) ABSTRACT

Systems and methods for document tracking and management are provided. A method may provide for providing an identification data to a remote user. The identification data may be associated with a first batch of documents. The method may comprise receiving the first batch of documents with the associated identification data from the remote user and storing an electronic file of each document in the first batch of documents in a document database, the electronic files associated with the identification data. The method may further provide for storing a tracking data indicative of the first batch of documents being forwarded to, and received by, an end user. The tracking data may be stored in the document database and associated with the identification data. Access to the electronic files of the first batch of documents to the remote user or the end user may also be provided.

### CROSS-REFERENCE TO RELATED APPLICATIONS

None.

### FIELD OF THE INVENTION

The present disclosure generally relates to a document system, and more particularly, to systems and methods for tracking and managing documents between users.

### BACKGROUND

Documents play an important role in virtually every industry. Documents provide, for example, evidentiary proof of the signatures of principal parties, proof of compliance with government or industry standards/regulations, and convey vital information. In an industry having multiple actors at different locations, documents are often transmitted between locations. It is, unfortunately, an all too common occurrence that the documents being mailed, shipped, etc., between such locations are lost, misdirected, and the like.

As an illustration, within the vehicle registration and driver licensing industry, physical documents are a necessary requirement to ensure compliance with, federal, state, and/or local laws and regulations, as well as to ensure ownership of vehicles is properly recorded. Generally, an individual desiring to obtain/renew a driver license or to title or register a vehicle (e.g., a car, a truck, a recreational vehicle, a watercraft, etc.) goes to his or her nearest tag agent and completes several mandatory documents. Exemplary mandated documents include, but are not limited to, an Application for Title or Registration, a Bill of Sale, an Odometer Disclosure Statement, Smog Certification, Safety Inspection Certification, etc. In some cases, the tag agent submits the completed title or registration documents to an independent party (may be referred to as a first line provider) for further submission to the Department of Motor Vehicles Agency (DMV). The DMV approves or rejects the documents and, if approved, records the registration.

However, current systems do not generally provide an effective document tracking and management system for such illustrative vehicle registration industry. For example, presently known systems do not provide a means for the tag agent to monitor the location of the documents. Further, presently known systems do not provide a mechanism wherein the third party has prior knowledge regarding the documents being sent from the remote user. Lastly, present systems do not provide for the tag agent and/or the DMV to be provided access to electronic copies of the documents. These and other known shortcomings render the presently known systems and methods generally unreliable and offer a poor choice for industries to effectively track and manage documents.

Thus, there is a need for an improved document tracking and management system, such as is presently disclosed.

### SUMMARY OF THE INVENTION

According to various embodiments, a method for providing document tracking and management is provided. The method may comprise providing, via a communications channel, an identification data to a remote user. The communications channel may be the Internet. The identification data may be associated with a first batch of title or registration documents. The method may comprise receiving the first batch of title or registration documents with the associated identification data from the remote user. The method may also comprise storing an electronic file of each document in the first batch of title or registration documents in a document database. Each of the electronic files may be associated with the identification data. The method may further comprise storing a tracking data indicative of the first batch of title or registration documents being forwarded to, and received by, a department of motor vehicles agency. The tracking data may be stored in the document database and associated with the identification data. Even further, the method may comprise providing access, via the communications channel, to the electronic files of the first batch of title and registration documents to the remote user or the department of motor vehicles agency. The files may be accessed based on the identification data. The identification data may be a barcode. The identification data may include information identifying the remote user and identifying a time period (e.g., a time period of one day) in which the remote user generated the first batch of documents.

The method may further comprise reviewing the first batch of title or registration documents received from the remote user to identify whether any document of the first batch of title or registration documents requires a corrective action. The method may provide for communicating to the remote user, via the communications channel, information indicative of the corrective action required by the remote user with respect to the first batch of title or registration documents. A correcting document may be received from the remote user, the correcting document being associated with the identification data. Aspects may provide for storing an error data for each remote user, the error data indicative of a frequency and type of corrective actions that are required for the remote user.

The first batch of title or registration documents may include one or more documents related to the title or registration of a vehicle, a recreational vehicle, a watercraft, etc. The remote user may be a tag agent. Additional aspect may provide for processing the electronic file using an optical character recognition module such that the electronic file is searchable by the remote user or the department of motor vehicles agency.

In accordance with further aspects of the present disclosure, a method for providing document tracking and management is provided. The method may comprise providing an identification data to a remote user. The identification data may be provided to the remote user via a communications channel, e.g., the Internet. The identification data may be associated with a first batch of documents. The first batch of documents may be generated by the remote user. The method may further provide for receiving the first batch of documents with the associated identification data from the remote user. An electronic file may be created for each of the documents in the first batch of documents and associated with the identification data. The electronic file of the documents in the first batch of documents and the associated identification data may be stored in a document database, e.g., a SQL database. The method may also provide for forwarding the first batch of documents to an end user for processing. Tracking data indicative of the first batch of documents being forwarded to, and received by, the end user may be stored in the document database and associated with the identification data. The method may even further comprise providing access, via the communications channel, to the electronic files of the first batch of documents being stored in the document database to the remote user or the end user. The remote user or end user may access the electronic files of the first batch of documents based on the identification data. The identification data may be a barcode.

Creating the electronic file may further comprise scanning each document of the first batch of documents so as to create the electronic file. The documents may be scanned with a digital scanner. The method may also provide for processing the electronic file using an optical character recognition module such that the electronic file is word searchable. The communications channel may be the Internet such that the remote and end users may be provided access to the electronic file of the first batch of documents via a web page. The method may also comprise reviewing the first batch of documents received from the remote user to identify whether any document of the first batch of documents require a corrective action, and further communicating information to the remote user indicative of the required corrective action. A correcting document may be received from the remote user in response to the remote user receiving the communicated corrective action. The first batch of documents may be forwarded to the end user after the correcting document has been received. Other aspects may provide for the identification data to include information identifying the remote user and identify a time period in which the remote user generated the first batch of documents. The time period may be one day.

An even further aspect of the present disclosure is a method for providing document tracking and management. The method may comprise storing an electronic file for each document of a first batch of documents. The electronic file may be stored in a document database, e.g., a SQL database. Each electronic file of the first batch of documents may be associated with an identification data, e.g., a barcode. Tracking data for the first batch of documents may be stored in the document database and associated with the identification data. The method may also comprise receiving a request for access to the electronic file of the first batch of documents from a user. The user may be a remote user or an end user. The remote user may be a tag agent. The end user may be a DMV Agency. The request may be received via a communications channel, e.g., the Internet. The request may include the identification data associated with the first batch of documents. The method may even further provide for querying the document database to identify the electronic file of the first batch of documents stored therein based on the identification data. The method may even further comprise providing access, via the communications channel, to the identified electronic file of the first batch of documents to the user. The electronic file may include the tracking data for the first batch of documents. The access to the identified electronic file may be provided via a web page communicated over the communications channel.

In accordance with even further aspects of the present disclosure, a document tracking and management system is provided. The system may comprise a communications module and a document database. The document database may be configured to store an electronic file for each document of a first batch of documents and an identification data associated with the first batch of documents. The document database may also be configured to store a tracking data for the first batch of documents. The tracking data for the first batch of documents may also be associated with the identification data. The system may further comprise a query module configured to, in response to a request from a user, the request including the identification data, identify the electronic file of the first batch of documents associated with the identification data. The system may even further comprise a presentation module configured to provide access to the user, via the communications module, to the electronic file of the first batch of documents associated with the identification data, wherein the presentation module may further provide to the user access to the tracking data for the first batch of documents. In accordance with certain aspects, the communications module is configured to communicate via a communications channel, e.g., the Internet, and the presentation module provides access to the electronic file to the user via a webpage.

The tracking data may include information indicative of the first batch of documents being forwarded to a department of motor vehicles agency. The user may be a business authorized to process a registration information, and further wherein the first batch of documents includes documents related to the registration of a vehicle, a recreational vehicle, or a watercraft. The user may be a department of motor vehicles agency authorized to approve or reject a registration. The system may further comprise an error reporting module configured to communicate a corrective action to the user in response to identification of an incorrect or missing document of the first batch of documents.

### BRIEF DESCRIPTION OF THE DRAWINGS

FIG. 1 is a block diagram illustrating certain aspects of the presently disclosed document tracking and management system and methods.

FIG. 2 is a block diagram of an exemplary provider system of the first line provider, in accordance with aspects of the present disclosure.

FIG. 3 is a flowchart of an exemplary method of providing document tracking and management, in accordance with aspects of the present disclosure.

FIG. 4 is a flowchart of another exemplary method of providing document tracking and management, in accordance with aspects of the present disclosure.

FIG. 5 is a flowchart of even another method of providing document tracking and management, in accordance with aspects of the present disclosure.

### DETAILED DESCRIPTION OF THE INVENTION

Before explaining the presently disclosed and claimed inventive concept(s) in detail by way of exemplary embodiments, drawings, and appended claims, it is to be understood that the present disclosure is not limited in its application to the details of construction and the arrangement of the components set forth in the following description or illustrated in the drawings. The present disclosure is capable of other embodiments or of being practiced or carried out in various ways. As such, the language used herein is intended to be given the broadest possible scope and meaning; and the embodiments are meant to be exemplary—not exhaustive. It is to be understood that the phraseology and terminology employed herein is for the purpose of description and should not be regarded as limiting. Unless otherwise required by context, singular terms may include pluralities and plural terms may include the singular.

The following description of the presently disclosed document tracking and management system is provided with reference to said system being implemented within the vehicle registration industry. As such, the description generally relates to the transfer and tracking of, and access to documents between at least one tag agent, an intermediary (i.e., a first line provider), and a DMV agency. However, it is to be understood that the present disclosure is not limited to the vehicle registration industry and is, instead, capable of being implemented in a variety of other industries. Such exemplary industries include, but are not limited to, the real estate industry (e.g., document tracking and management between agents, closing agents, inspectors, lending institutions, etc.), the banking industry (e.g., document tracking and management between lending institutions, clearing facilities, etc.) as well as any other industry which would benefit from the present disclosure.

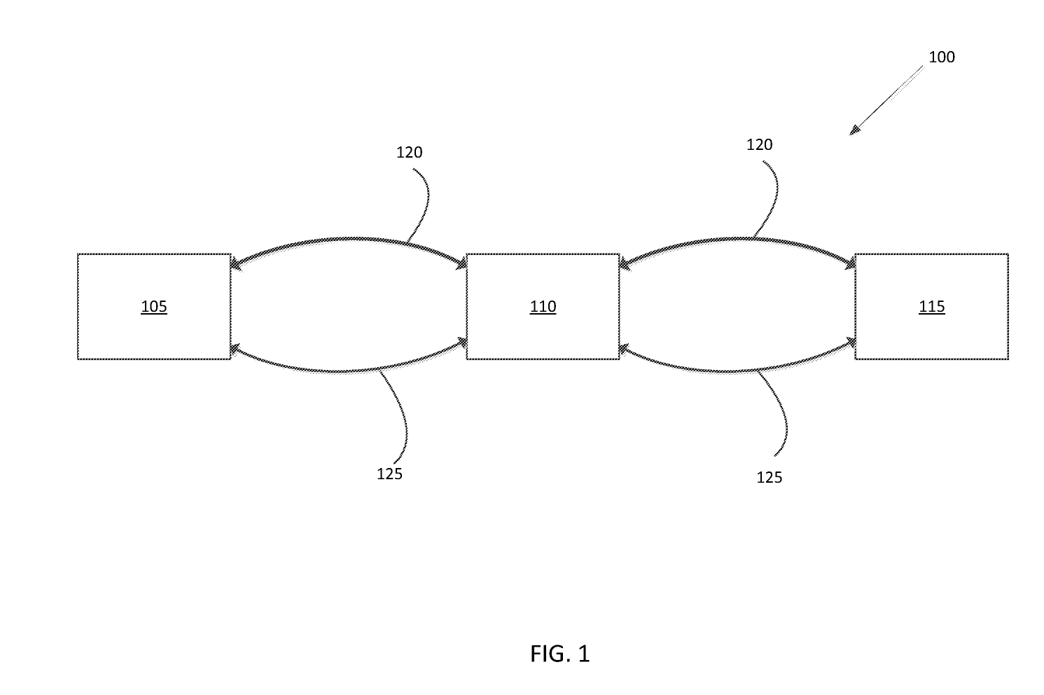

Referring now to FIG. 1, shown therein is a block diagram illustrating certain aspects of the presently disclosed document tracking and management system and methods. Generally, FIG. 1 illustrates a system 100 which may implement aspects of the present disclosure. The system 100 may comprise a remote user 105, a first line provider 110, and an end user 115. The remote user 105 and/or the end user 115 may communicate with the first line provider 115 via a communications channel 120. The remote user 105 and/or the end user 115 may exchange one or more physical documents, or a batch of documents via a path 125.

The remote user 105 may be a business authorized to process a registration information, e.g., a tag agent. The remote user 105 may be authorized to prepare/complete state-mandated documents related to driver licensing as well as the titling and/or registration of a vehicle, e.g., a motor vehicle, a recreational vehicle, a sport utility vehicle, a watercraft, etc. Exemplary mandated documents include, but are not limited to, an Application for Title or Registration, a Bill of Sale, an Odometer Disclosure Statement, Smog Certification, Safety Inspection Certification, etc. Although one remote user 105 is shown in FIG. 1, it is to be understood that the present disclosure may comprise more than one, i.e., a plurality of remote users 105. The remote user 105 may comprise a remote user terminal (not shown) wherein, as the remote user 105 completes or prepares documents relating to such registration information, information is transmitted to the first line provider 115, via the communications channel 120, that is indicative of the nature of the completed documents, e.g., information indicative of a new registration for a recreational vehicle being issued to a first customer, information indicative of a renewal registration for a motorcycle being issued to a second customer, etc. The remote user terminal may comprise a communication mechanism adapted to permit the remote user 105 and the first line provider 110 to communicate via the communications channel 120. The communications channel 120 may be a private network of interconnected terminals or a public network, e.g., the Internet. The remote user terminal may be implemented as a point-of-sale terminal, a personal computer, a laptop, a smart phone, a terminal computer, etc.

The end user 115 may be a Department of Motor Vehicles Agency (DMV). The end user 115 may be a federal, state, and/or local agency authorized to approve or reject licensing, title, and/or registration information. For example, the end user 115 may be authorized to register a vehicle to a particular customer in response to the remote user 105 completing said registration information for the customer. Also, although one end user 115 is shown in FIG. 1, it is to be understood that the present disclosure may comprise more than one, i.e., a plurality of end users 115.

The path 125 may be configured to transfer, ship, or mail the physical documents between the parties, e.g., between the remote user 105 and the first line provider 110 and/or between the end user 115 and the first line provider 110. The path 125 may be implemented via the United States Postal Service, a third party carrier (e.g., Fedex®, UPS®, etc.), and/or a commercial or private courier service. The path 125 may be adapted to provide a tracking data with respect to the documents being transferred or shipped via the path 125. The tracking data may be a tracking identification number and include information indicative of the date/time and location from which the documents were shipped, the physical location of the documents as the documents transit along the path 125, and the date/time and location of the party receiving the documents.

The following exemplary operational description is provided by way of example only and is not to be considered limiting. In operation, the remote user 105 may be a tag agent that generates or otherwise prepares one or more documents for each transaction. For example, a vehicle registration renewal for a first customer may require the remote user 105 to prepare an Odometer Certificate, a Request for Registration, an Insurance Verification Certificate, etc. As the remote user 105 completes each transaction, or at the end of the day, information is provided to the first line provider 110 via the communications channel 120. The information may include data indicating that, for that business day, the remote user 105 has completed seven transactions (e.g., three vehicle registration renewals, two new vehicle registrations, and three licenses being issued) and that the remote user 105 has completed business for that day and is preparing to convey the documents to the first line provider 110. The documents generated by the remote user 105 for that day may be referred to as a first batch of documents. That is, a first batch of documents may refer to one or more documents being transmitted from the remote user 105 to the first line provider 110 via the path 125. Within the first batch of documents, there could be, for example, 5 documents for each vehicle registration renewal, 3 documents for each licenses being issued, etc. Collectively, the documents generated by the remote user 105 for a predetermined time period (e.g., one day, one week, one month, etc.) may be the first batch of documents.

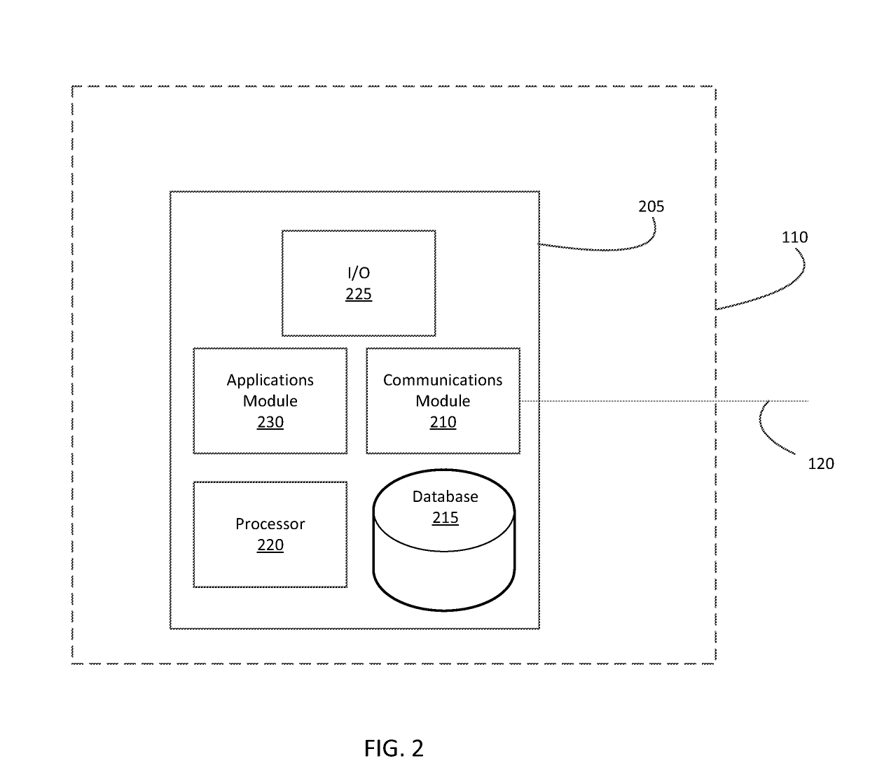

In response to the first line provider 110 receiving the information regarding the batch of documents from the remote user 105, the first line provider 110 may provide an identification data to the remote user 105. For example, the first line provider 110 may comprise a provider system (discussed in greater detail with reference to FIG. 2) that may generally be referred to as a computerized processing system (e.g., a server, a virtual server, a personal computer, laptop, etc.). The identification data may be automatically generated by the provider system and include a unique number that is associated with that particular batch of documents. In one example, the identification data may be implemented as a barcode. The identification data may include information indicating which remote user 105 generated the first batch of documents, what predetermined time period the first batch of documents was generated, etc. The remote user 105 may print a summary sheet that includes the identification data and attach, or otherwise associate the summary sheet to the first batch of documents so as to thereby associate the identification data to the first batch of documents. The remote user 105 then conveys the first batch of documents to the first line provider 110 via the path 125. For example, the remote user 105 may mail the first batch of documents with the associated identification data via the United States Postal Service.

The first batch of documents with the associated identification data is received at the first line provider 110. The first line provider 110 may The first line provider 110 may utilize the provider system to input or otherwise record receipt of the first batch of documents from the remote user 105. As one example, the first line provider 110 may scan the identification data (e.g., barcode) upon initial receipt of the first batch of documents. The provider system may be configured to store information, in a document database, indicative of the specifics of the first batch of documents. That is, the provider system may store such exemplary information in the document database, for each batch of documents, as when the remote user 105 initially transmitted information to the first line provider 110 that the first batch of documents was generated, the data and time of when the first batch of documents was received by the first line provider 110, etc. The provider system may implement the document database as a SQL database wherein all of the information contained in the document database is readily accessible using, for example, the identification data.

Once the first line provider 110 has received the first batch of documents, various other functions can be performed at the provider 110 level. In accordance with certain aspects, the first line provider 110 may create an electronic file for each of the documents in the first batch of documents. In this case, the electronic file is associated with the identification data. For example, the first line provider 110 may scan each of the documents into the document database using a flatbed, or sheet feed scanner. The electronic files may be saved in the portable document format (pdf), as an image file (e.g., tiff, jpg, bmp, etc.), or other file format. The electronic file of the first batch of documents is stored in the document database and associated with the identification data. Associating each electronic file with the identification data in the document database may permit ready identification and retrieval of the file based on the identification data. That is, a user may query the document database using the identification data so as to identify the electronic file and retrieve the electronic file for presentation to the user. In one embodiment, the first line provider 110 may optionally process the electronic file using, for example, an optical character recognition (OCR) program or module. The OCR'd electronic file may then be word searchable such that a user may query the document database using, for example, a customer name, so as to identify and retrieve the electronic file. The user may also then query the document database using the identification data associated with the first batch of documents and also the customer's name to reduce the number of identified electronic file hits.

Once the first line provider 110 has entered information into the document database indicating receipt of the first batch of documents, the provider system may be configured such that the remote user 105 may access the document database so as to identify and be presented information associated with the first batch of documents. For example, the remote user 105 may query the document database using the identification data so as to be presented with information confirming receipt of the first batch of documents by the first line provider 110. The remote user 105 may also be permitted to retrieve the electronic files of the first batch of documents for viewing. In one example, the communications channel 120 is the Internet and the remote user 105 accesses the electronic files via one, or a series of web pages being provided by the provider system.

The first line provider 110 may then forward the first batch of documents to the end user 115. The tracking data may be stored in the document database and associated with the identification data. The first batch of documents may be forwarded to the end user 115 via the path 125. The tracking data may include information indicative of the first batch of documents being forwarded to, and received by the end user 115. As one example, the path 125 may be implemented via a commercial carrier (e.g., Fedex®) wherein the carrier provides the first line provider 110 a tracking identification number and access to real-time monitoring of the location of the first batch of documents as they progress from the location of the first line provider 110 to the location of the end user 115. The first line provider may, via the provider system, for example, store the real-time location of the first batch of documents in the document database as a part of the tracking data. When the first batch of documents is received by the end user 115, e.g., when an individual associated with the end user 115 signs for the first batch of documents, the document database may be updated to include information indicating when , and by whom the first batch of documents has been received by the end user 115. As mentioned above, the end user 115 may be a DMV agency and may process the documents, e.g., the DMV agency may review, approve, and record the registration of a vehicle associated with at least a portion of the documents included in the first batch of documents.

Further, the remote user 105 may access the document database using the identification data so as to be presented with the tracking data such that the remote user 105 and/or the first line provider 110 may have confirmation that the first batch of documents was received at the end user 115.

Another aspect of the presently disclosed document tracking and management system is the improved access to the electronic files and the tracking data for both the remote user 105 and the end user 115. That is, the first line provider 110 may provide access to the electronic files of the first batch of documents. The access may be provided via the communications channel 120 and may be based on the identification data. As one example, the remote user 105 and/or the end user 115 may access the provider system via the communications channel 120 and enter the identification data into a query module. The query module may search the document database to identify the electronic file and/or the tracking data associated with the identification data. As such, the remote user 105 and/or the end user 115 may be presented with information indicative of when (date/time) the first batch of documents being received by the first line provider 110, when the first batch of documents was forwarded to the end user, when the first batch of documents was received by the end user 115, and which individual associated with the end user 115 received (e.g., signed for) the first batch of documents. In situations where multiple parties are involved in a transaction, the presently disclosed document tracking and management system provides a one-stop system for each of the parties to access the flow of the documents through the process as well as confirmation of each parties completion of their respective step.

The remote user 105 and/or the end user 115 may also be provided access to the electronic files of the first batch of documents. The remote user 105 and/or the end user 115 may be provided access to the electronic files based on the identification data. That is, the remote user 105 and/or the end user 115 may access the provider system and enter the identification data as an input to a query module. The query module may search the document database to identify the electronic files associated with the identification data and present the electronic files to the requestor. As such, the remote user 105 and/or the end user 115 may be presented with a file that includes information indicative of each document in the first batch of documents. In one example, the electronic file may be an image (e.g., pdf, jpg, etc.) of the original document of the first batch of documents. In the case of the vehicle registration industry, the tag agent and/or the DMV agency may access the electronic files based on the identification data associated with the first batch of documents so as to, for example, confirm the presence of particular documents, print a copy of the original document, etc.

Other aspects of the present disclosure provide for the first line provider 110 to review the first batch of documents received from the remote user 105 to identify whether any document of the first batch of documents requires a corrective action. The review may include reviewing the first batch of documents to determine if any of the documents in the first batch of documents is missing, incomplete, etc. In the case of a vehicle registration, such a transaction may have state-mandated documents including a Request to Register a Vehicle, an Odometer Statement, a Smog Inspection, and a Insurance Verification Certificate. The first line provider 110 may, based on the initial information provided by the remote user 105 for the predetermined time period and the state-mandated forms for such transaction, review the first batch of documents to ensure that each required document is present, that each document is completed properly, that all the necessary signatures are present, etc. In the case where an error is identified, the first line provider 110 may communicate to the remote user 105 the corrective action. The corrective action may be communicated to the remote user 105 via the communications channel 120. The corrective action may be communicated to the remote user 105 as, for example, an email message, as a text message transmitted over a cellular telephone message, etc. The corrective action may include information indicating which documents are missing, which signatures are missing, which documents are completed improperly, etc. The remote user 105 may access the provider system using the identification data to review the electronic file of the first batch of documents, if desired. The remote user 105 may, in response to receiving the corrective action, remedy the error and then provide a correcting document to the first line provider 110. The correcting document may be associated with the identification data. The first line provider 110 may delay forwarding the first batch of documents to the end user 115 until the correcting document has been received and associated with the first batch of documents. That is, the first line provider 110 may hold the first batch of documents until the remote user 105 has an opportunity to provide the correcting document remedying the error. Once the correcting document has been received, the first line provider 110 may then forward the first batch of documents to the end user for processing. It is to be understood that mandatory deadlines covering the time period within which the end user must receive the first batch of documents may prevent the first line provider 110 from holding the first batch of documents for an indeterminable time. In this case, the first line provider 110 may then be forced to forward the first batch of documents to the end user 115 for processing.

Other aspects may provide for error data to be stored for each remote user 105. The error data may be stored by the first line provider 110. The error data may include information indicative of the frequency and type of corrective actions that are required for the remote user 105. The error data may be communicated to the remote user 105, wherein the remote user 105 analyzes the error data to identify particular areas that need to receive further training. For example, if the remote user 105 is a tag agent and five of the previous ten vehicle registration documents is missing the Smog Statement, said error data may include information indicating to that tag agent that additional training is required of its employees to ensure better compliance with the Smog Statement requirement. The error data may be stored in the document database, or a different database of the provider system of the first line provider 110. The error data may be forwarded to the remote user 105 via, for example, the communications channel 120.

With reference to FIG. 2, shown therein is a block diagram of an exemplary provider system 205 of the first line provider 110. The provider system 205 comprises a communications module 210, a document database 215, a processor 220, an Input/Output (I/O) 225, and an applications module 230. Broadly, the system 205 may be implemented as a processor-based computing system, e.g., a personal computer, a laptop, a smart phone, a netbook, etc. Other aspects may provide for the system 205 to be implemented as a real and/or virtual server, or a series of servers operating on a network environment and communicating over, for example, the Internet. The system 205 may be utilized by the first line provider 110 to implement aspects of the presently disclosed document tracking and management system.

The communications module 210 is configured, or otherwise adapted to communicate via the communications channel 120. The communications module 210 may be implemented as a network interface card operating on the system 205 and being configured to communicate with, for example, the remote user 105 via the communications channel 120. The system 205 may be adapted to transmit to and/or receive information from the remote user 105 and/or the end user 115, utilizing the communications module 210.

The document database 215 may be configured to store data, electronic files, variables, etc. Exemplary implementations of the document database 215 include, but are not limited to, a sequel (SQL) database, collaborative database, etc. The document database 215 may include logic instructions such that the information stored thereon is managed in a relational database management system (RDBMS). The document database 215 may be implemented as a single database, or a plurality of databases in communication. Further, the document database 215 may be stored on a single storage device within the system 205 or may be distributed amongst multiple storage devices, e.g., one or more hard drives. Other aspects may provide for the document database 215 to be implemented via an online storage provider wherein the system 205 searches, stores, and retrieves information from the document database 215 via the communications module 210 communicating via the communications channel 120.

The processor 220 may comprise one or more processors adapted to execute computer-executable code provided by, for example, the applications module 230. The processor 220 may be in communication with other components of the system 205 via one or more system buses so as to exchange information, data, etc. The processor 220 may comprise an integrated memory component temporarily storing data, information, or variables being utilized in conjunction with the processor 220 executing instructions.

The applications module 230 may comprise one or more modules adapted to perform certain aspects of the presently disclosed document tracking and management system. The modules may be implemented as computer executable code that, when executed, cause the system 205 to carry out aspects of the presently disclosed document tracking and management system. The applications module 230 may include code stored on a memory device that is accessible by the processor 220 so as to be executed thereon. The applications module 230 may further include instructions or code configured to operate and/or control system-level functions of the system 205, e.g., data routing, operating system, etc.

In accordance with certain aspects, the applications module 230 may comprise a query module and a presentation module. The query module may permit, or be otherwise configured to, in response to receiving a request including the identification data from a user, identify an electronic file of a first batch of documents being stored in the document database 215. The query module may be in communications with the document database 215 so as to search the information stored therein to locate the first batch of documents, from amongst other batches of documents, the user seeks to locate. The presentation module may be configured to provide access to the user to the electronic file of the first batch of documents associated with the identification data. The presentation module may further provide access to the tracking data for the first batch of documents. The presentation module may further be configured to present the electronic file and/or the tracking data to the user via one or more web pages communicated via the communications channel 120. That is, the presentation module may be configured to permit the user to enter the identification data into a search field of a website and, in response, render the electronic file for viewing by the user via the webpage.

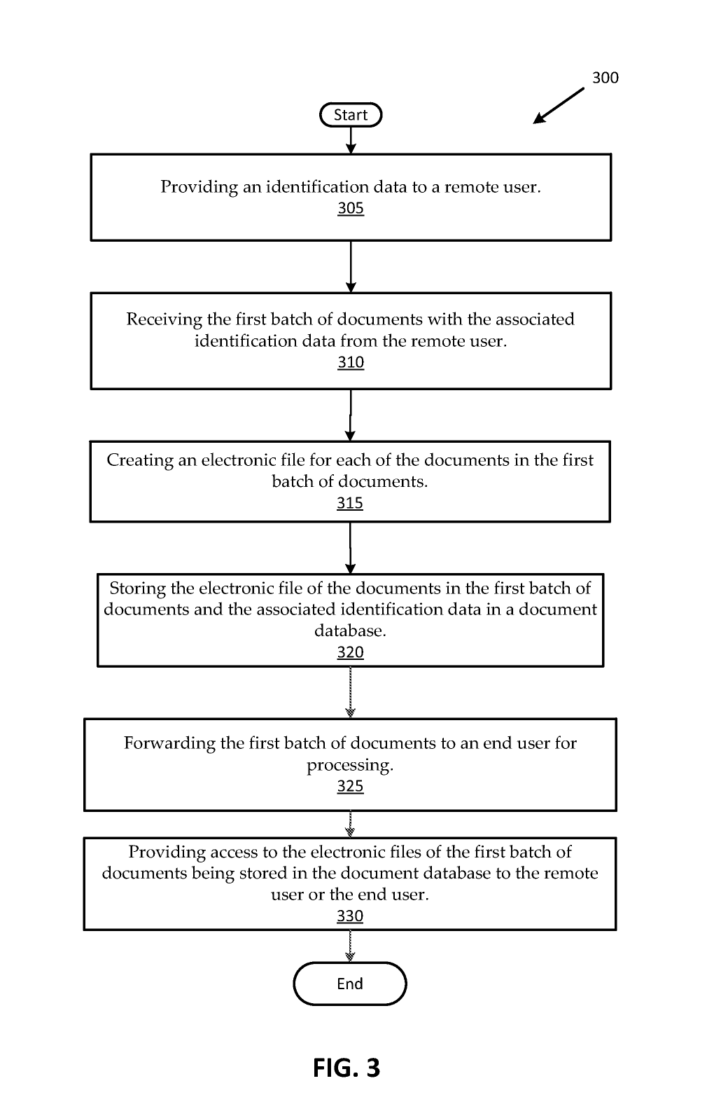

Referring now to FIG. 3, shown therein is a flowchart of an exemplary method 300 of providing document tracking and management. The method 300 may comprise a step 305 of providing an identification data to a remote user, e.g. the remote user 105. The identification data may be provided to the remote user via the communications channel 120. The identification data may be associated with a first batch of documents. The first batch of documents may include physical documents prepared by the remote user. In accordance with certain aspects, the identification data provided to the remote user is a barcode. The identification data may include information identifying the remote user and, optionally, identify a time period in which the remote user generated the first batch of documents. The remote user may attach, or otherwise associate the identification data with the first batch of documents. The first batch of documents may include a plurality of documents relating to the registration of one or more vehicles by the remote user for the predetermined time, e.g., a day. That is, the first batch of documents may include all of the documents that the remote user has generated or otherwise prepared on a business day for the title or registration of the vehicle, a recreational vehicle, a watercraft, etc.

The method 300 may further comprise a step 310 of receiving the first batch of documents with the associated identification data from the remote user. The first batch of documents with the associated identification data may be received by the first line provider 110. The first batch of documents with the associated identification data may be shipped from the remote user to the first line provider via the path 125. In accordance with certain aspects, the remote user may provide to the first line provider 110 a tracking number associated with first batch of documents being shipped such that the first line provider 110 can monitor and record receipt of the first batch of documents.

The method 300 may further comprise a step 315 of creating an electronic file for each of the documents in the first batch of documents. The electronic file may be associated with the identification data. The electronic file may be created by scanning each document of the first batch of documents using a scanner. Certain aspects may provide for utilization of an optical character recognition module to process each of the electronic files such that said files are word searchable. Processing the electronic files by the optical character recognition module may be completed contemporaneously at the initial creation of electronic files or performed as a subsequent step.

The method 300 may further comprise a step 320 of storing the electronic file of the documents in the first batch of documents and the associated identification data in a document database, e.g., the document database 215. The electronic files stored in the document database may be word searchable such that a user can locate and retrieve information contained in electronic files via a query module.

The method 300 and may also comprise a step 325 of forwarding the first batch of documents to an end-user for processing, e.g., the end user 115. Tracking data may include information indicative of the first batch of documents being forwarded to, and received by, the end user. The tracking data may be stored in the document database and associated with the identification data. The end user may be a DMV agency.

The method 300 and may comprise a step 330 of providing access to the electronic files of the first batch of documents being stored in the document database to the remote user or the end-user. The access may be provided via the communications channel, e.g., the communications channel 120. The remote user or end user may access the electronic files of the first batch of documents based on the identification data. For example, the remote user or the end-user may access the document database via the Internet and through one or more webpages configured to permit a user to enter the identification data associated with the first batch of documents so as to search the document database and retrieve the electronic file and/or the tracking data.

Alternate embodiments of the method 300 may provide for reviewing the first batch of documents received from the remote user to identify whether any document of the first batch of documents require a corrective action. Information indicative of the required corrective action may be communicated to the remote user via the communications channel. The first batch of documents may be reviewed by the first line provider to ensure compliance with state mandated regulations and procedures. For example, the first line provider may review the first batch of documents so as to ensure each required document necessary to register a vehicle is present and properly completed. In the case where the remote user is required to make a corrective action, the method 300 may further comprise receiving a correcting document from the remote user in response the remote user receiving the communicated corrective action. For example, when the review indicates that the first batch of documents includes a group of documents associated with the registration of the vehicle for a particular customer of the remote user wherein at least one of the documents is missing or improperly completed, the corrective action may notify the remote user such that the remote user can reconnect with the customer to remedy the incorrect registration documents. Once corrected, the remote user may forward the correcting document to the first line provider wherein the correcting document is further associated with the identification data so as to thereby remedy the previously identified corrective action.

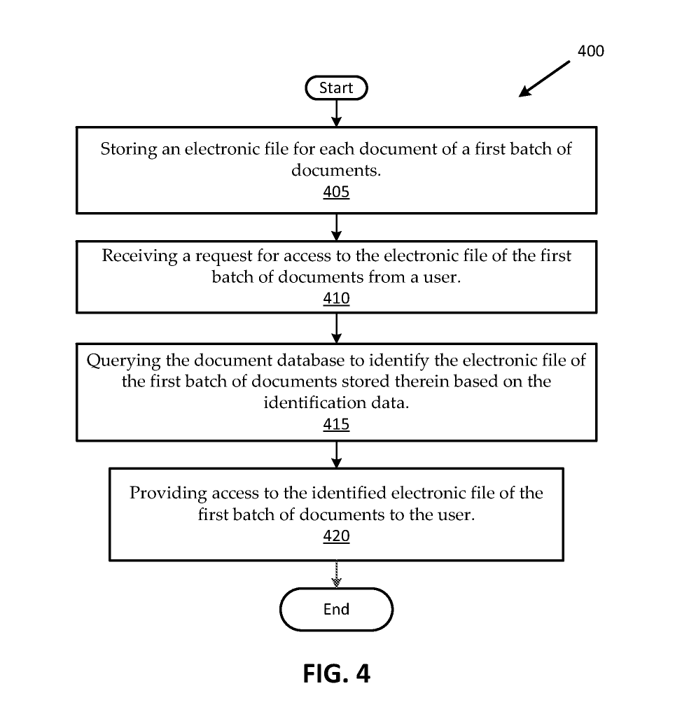

Turning now to FIG. 4, shown therein is alternate exemplary method 400 for providing document tracking and management. The method 400 may comprise a step 405 of storing an electronic file for each document of the first batch of documents. The electronic file may be stored in a document database, e.g. the document database 215. Each electronic file of the first batch of documents may be associated with the identification data. Tracking data for the first batch of documents is further stored in the document database and associated with the identification data.

The method 400 may also comprise a step 410 of receiving a request for access to the electronic file of the first batch of documents from a user. The user may be the remote user, or the end-user, e.g. a tag agent or the DMV agency. The request may be received via the communications channel e.g. the communications channel 120. The request may include the identification data that is associated with the first batch of documents.

The method 400 may also comprise a step 415 of querying the document database to identify the electronic file of the first batch of documents stored therein based on the identification data. For example, the user may enter the identification data into a webpage and then select the search button so as to activate a search function within the provider system 205. The method 400 and may utilize, for example, the query module of the applications module 215 discussed above.

Lastly, the method 400 may comprise a step 420 of providing access to the identified electronic file of the first batch of documents to the user. The access may be provided via the communications channel 120. As tracking data is also associated with the identification data, the user is also provided access to the tracking data for the first batch of documents. The user may access the electronic file and/or the tracking data via a web page being generated and presented to the user by the provider system 205.

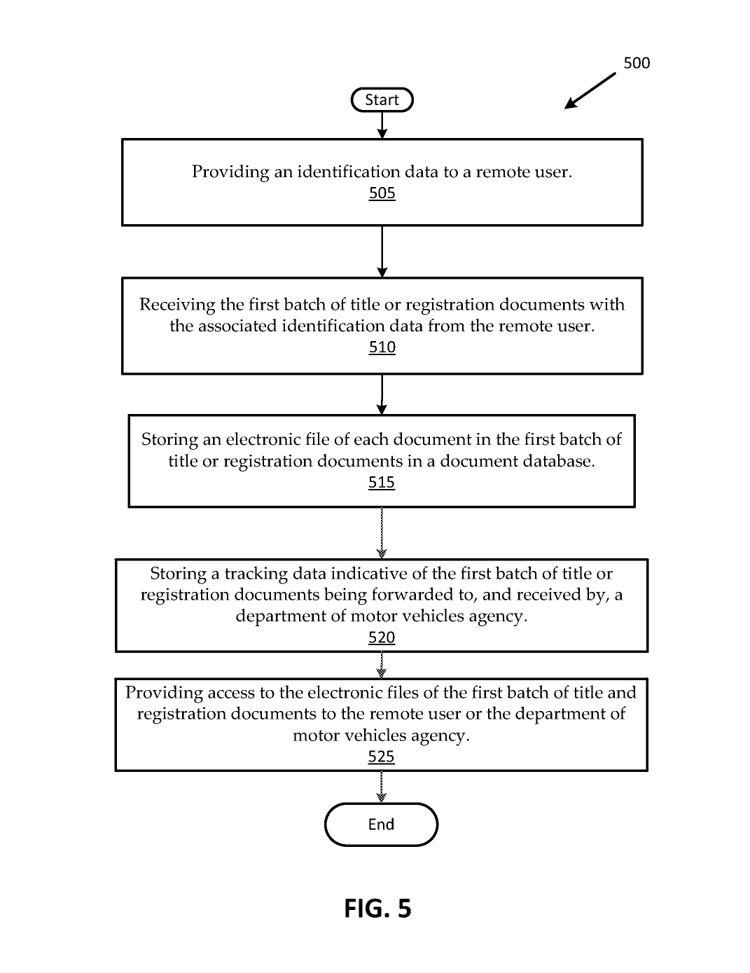

Turning now to FIG. 5, shown therein is an even further alternate embodiment of a method 500 of providing document tracking and management. The method 500 may comprise a step 505 of providing an identification data to remote user. The identification data may be associated with a first batch of title or registration documents. The identification data may be provided to the remote user via a communications channel e.g. the communications channel 120. The remote user may then associate the identification data with the first batch of title or registration documents. The remote user may be a tag agent.

The method 500 may further comprise a step 510 of receiving the first batch of title or registration documents with the associated identification data from the remote user. The first batch of title or registration documents may be received by the first line provider, e.g., the first line provider 110. The first line provider may record or otherwise document receipt of the first batch of title registration documents based on the associated identification data. For example, the first line provider may scan the identification data into the system 205 discussed above so as to store information associated with the first batch of title registration documents in the document database.

The method 500 may also comprise a step 515 of storing an electronic file of each document in the first batch of title or registration documents in a document database. Each of the documents of the first batch of title registration documents may be scanned by the first line provider so as to create and store the electronic file. The electronic file stored in the document database may include or otherwise be associated with the identification data.

The method 500 may even further comprise a step 520 of storing and tracking data indicative of the first batch of title registration documents being forwarded to, and received by, a Department of Motor Vehicles agency. For example, the first line provider may record and store in the document database a tracking data or a tracking number associated with the first batch of title registration documents being forwarded to the DMV agency. Information indicative of the DMV agency receiving the documents of the first batch of title and registration documents may also be stored in a document database and associated with the identification number as a component of the tracking data.

The method 500 may also comprise a step 525 of providing access to the electronic files of the first batch of title and registration documents to the remote user or the DMV agency. The access may be routed to the remote user or the DMV agency via the communications channel, e.g. the communications channel 120. The electronic files may be accessed via the remote user or the DMV agency based on the identification data. That is, the remote user or the DMV agency may access the electronic file of the first batch of title registration documents by entering the identification data into, for example, a webpage being provided by the provider system 205 of the first line provider 110 wherein the query module searches and returns the identified electronic file for presentation to the remote user or DMV agency.

While the present invention has been described in connection with a series of preferred embodiments, these descriptions are not intended to limit the scope of the invention to the particular forms set forth herein. The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents. The present descriptions are intended to cover such alternatives, modifications, and equivalents as may be included within the spirit and scope of the invention as defined by the appended claims and otherwise appreciated by one of ordinary skill in the art. In several respects, embodiments of the present invention may act to close the loopholes in the current industry practices in which good business practices and logic are lacking because it is not feasible to implement with current resources and tools.

1. A method for providing document tracking and management, the method comprising:
providing by a first line provider, via a communications channel, an identification data to a remote user, the identification data representing a time period of one day, one week or one month in which the remote user completed preparation or generation of a plurality of title or registration documents that collectively form a first batch of title or registration documents, the identification data to be associated with the first batch of title or registration documents before the first batch of title or registration documents is received by the first line provider and the identification data identifying the remote user;
receiving by the first line provider the first batch of title or registration documents with the associated identification data from the remote user;
storing an electronic file of each document in the first batch of title or registration documents in a document database, each of the electronic files being associated with the identification data;
storing, in the document database, a tracking data indicative of the first batch of title or registration documents being forwarded to, and received by, a department of motor vehicles agency, the tracking data being associated with the identification data; and
providing access, via the communications channel, to the electronic files of the first batch of title and registration documents to the remote user and the department of motor vehicles agency, wherein the files are accessed based on the identification data.

2. The method of claim 1, wherein the identification data is a barcode.

3. The method of claim 1, further comprising reviewing the first batch of title or registration documents received from the remote user to identify whether any document of the first batch of title or registration documents requires a corrective action.

4. The method of claim 3, further comprising communicating to the remote user, via the communications channel, information indicative of the corrective action required by the remote user with respect to the first batch of title or registration documents.

5. The method of claim 4, further comprising receiving a correcting document from the remote user, the correcting document being associated with the identification data.

6. The method of claim 3, further comprising storing an error data for each remote user, the error data indicative of a frequency and type of corrective actions that are required for the remote user.

7. The method of claim 1, wherein the identification data includes information identifying the remote user and identifying a time period in which the remote user generated the first batch of documents.

8. The method of claim 7, wherein the time period is one day.

9. The method of claim 1, wherein the remote user is a business authorized to process a title or registration information, and further wherein the first batch of title or registration documents includes documents related to the title or registration of a vehicle, a recreational vehicle, or a watercraft.

10. The method of claim 1, further comprising processing the electronic file using an optical character recognition module such that the electronic file is searchable by the remote user or the department of motor vehicles agency.

11. A method for providing document tracking and management, the method comprising:
providing by a first line provider, via a communications channel, an identification data to a tag agent, the identification data representing a time period of one day, one week, or one month in which the tag agent completed preparation or generation of a plurality of title or registration documents that collectively form a first batch of title or registration documents, the identification data to be associated with the first batch of documents before the first batch of documents is received by the first line provider and the identification data identifying the remote user and a time period in which the remote user generated the first batch of documents;
receiving by the first line provider the first batch of documents with the associated identification data from the tag agent;
creating an electronic file for each of the documents in the first batch of documents, the electronic file being associated with the identification data;
storing the electronic file of the documents in the first batch of documents and the associated identification data in a document database;
forwarding the first batch of documents to an end user for processing, wherein tracking data indicative of the first batch of documents being forwarded to, and received by, the end user is further stored in the document database and associated with the identification data; and
providing access, via the communications channel, to the electronic files of the first batch of documents being stored in the document database to the tag agent or the end user, wherein the tag agent or end user accesses the electronic files of the first batch of documents based on the identification data.

12. The method of claim 11, wherein the identification data is a barcode.

13. The method of claim 11, wherein creating the electronic file further comprises scanning each document of the first batch of documents so as to create the electronic file.

14. The method of claim 13, further comprising processing the electronic file using an optical character recognition module such that the electronic file is word searchable.

15. The method of claim 11, wherein the tag agent and the end user are provided access to the electronic file of the first batch of documents via a web page.

16. The method of claim 11, further comprising reviewing the first batch of documents received from the tag agent to identify whether any document of the first batch of documents require a corrective action, and further communicating information to the tag agent indicative of the required corrective action.

17. The method of claim 16, further comprising receiving a correcting document from the tag agent in response to the tag agent receiving the communicated corrective action, wherein the first batch of documents are forwarded to the end user after the correcting document is received.

18. The method of claim 11, wherein the identification data includes information identifying the tag agent and identify a time period in which the tag agent generated the first batch of documents.

19. A method for providing document tracking and management, the method comprising:
storing, in a document database, an electronic file for each document of a first batch of documents, wherein each electronic file of the first batch of documents is associated with an identification data, the identification data representing a time period of one day, one week or one month in which a remote user completed preparation or generation of the first batch of title or registration documents, and further wherein tracking data for the first batch of documents is further stored in the document database and associated with the identification data and the identification data identifying the remote user;
receiving, via a communications channel, a request for access to the electronic file of the first batch of documents from a user, the request including the identification data associated with the first batch of documents;
querying the document database to identify the electronic file of the first batch of documents stored therein based on the identification data; and
providing access, via the communications channel, to the identified electronic file of the first batch of documents to the user, wherein the electronic file may include the tracking data for the first batch of documents.

20. The method of claim 19, wherein the identification data is a barcode.

21. The method of claim 19, wherein the tracking data includes information indicative of the first batch of documents being forwarded to a department of motor vehicles agency.

22. The method of claim 19, wherein the document database is a SQL database.

23. The method of claim 19, wherein the user is provided access to the identified electronic file via a web page communicated over the communication channel.

24. The method of claim 19, further comprising reviewing the first batch of documents to identify a required corrective action such that the user providing the first batch of documents can provide a correcting document to remedy the required corrective action.

25. A document tracking and management system comprising:
a processor;
a communications module;
a document database configured to store an electronic file for each document of a first batch of documents and an identification data associated with the first batch of documents, the document database further configured to store a tracking data for the first batch of documents, the tracking data for the first batch of documents also being associated with the identification data and the identification data identifying a remote user and a time period of one day, one week or one month in which the remote user prepared or generated the first batch of documents;
a query module executed by the processor to, in response to a request from a user, the request including the identification data, identify the electronic file of the first batch of documents associated with the identification data; and
a presentation module executed by the processor to provide access to the user, via the communications module, to the electronic file of the first batch of documents associated with the identification data, wherein the presentation module may further provide to the user access to the tracking data for the first batch of documents.

26. The system of claim 25, wherein the communications module is configured to operate on the Internet and the presentation module provides access to the electronic file to the user via a webpage.

27. The system of claim 25, wherein the tracking data includes information indicative of the first batch of documents being forwarded to a department of motor vehicles agency.

28. The system of claim 25, wherein the user is a business authorized to process a registration information, and further wherein the first batch of documents includes documents related to the registration of a vehicle, a recreational vehicle, or a watercraft.

29. The system of claim 28, wherein the user is a department of motor vehicles agency authorized to approve or reject a registration.

30. The system of claim 25, further comprising an error reporting module configured to communicate a corrective action to the user in response to identification of an incorrect or missing document of the first batch of documents.
